(19) United States
(12) Patent Application Publication
(10) Pub. No.: US 2015/0088601 A1
(43) Pub. Date: Mar. 26, 2015

(54) SYSTEM FOR CAPTURING AND ENGAGING PROSPECTS

(71) Applicant: Carlos Felix Gimbernard, Weston, FL (US)

(72) Inventor: Carlos Felix Gimbernard, Weston, FL (US)

(21) Appl. No.: 14/037,076

(22) Filed: Sep. 25, 2013

(51) Int. Cl. G06Q 30/02

(52) U.S. Cl. CPC G06Q 30/0241; G06Q 30/0207; G06Q 30/0201
USPC 705/7.29; 705/14.1

(57) ABSTRACT

A system for true one to one advertising where prospects are exposed to messages that attract them requesting them to provide their electronic mail information and identifiers associated with the messages seen by the prospects. In addition to the offered incentives, a server selectively sends subsequent sets of information to participants based on predetermined conditions, with additional awards or probabilities of earning awards, to prompt replies relevant to sponsors advertising their goods and/or services. As the participant becomes engaged with the system, the sponsors formulate offers for products and/or services based on the replies received. Marketing reports are compiled from the information received and forwarded to the sponsors measuring the penetration of their advertising messages.

### BACKGROUND OF THE INVENTION

1. Field of the Invention

The present invention relates to a marketing and advertising system.

2. Description of the Related Art

Advertisers spend billions of dollars in conventional advertising each year with poor results. Advertising messages do not reach most consumers and do not create the impact required by advertisers regardless of the media used. There is a need to improve the effectiveness of advertising and presentation. The two options to improve the odds for conveying the advertising message to the consumer are increasing advertising expenditures and/or getting smarter (more effective advertising).

The present business method follows the latter providing a more efficient means to convey the message to consumers thereby achieving the advertising goals. Additionally, the present method measures the impact and effectiveness of the advertising. This guarantees a fair return on the advertiser's investment.

The present invention is a business method that includes an attention grabber or promotion program, such as a lighted car-stopper advertising, and this is coupled with a rewards program and an engagement program. The customer or potential customer (hereinafter the prospect) is initially exposed to Applicant's advertising method through an attention grabber program that may include displays of different types including those in the lighted car-stopper advertising assemblies, or signs, printed, media, etc that attracts the prospect with graphics and messages as the they come within visual reach of the displays, ie. park their vehicles (paying close attention to the bunker/display they are approaching), or other displays that initially catch the prospect's attention. The displays include a predetermined identifier. It is inevitable for a prospect to direct his/her attention to where he/she is parking and thus the car stopper advertising is particularly well suited for this method. The prospects are then asked to provide their electronic addresses (email, SMS or other) and the display identifier. Then, the prospect is directed to our rewards program where incentives and rewards are given as different cyberspace areas are visited and actions taken.

Subsequently, a server with a rewards program (for example, in the form of trivia questions for which answers will be accepted) is used. The sponsors of the advertisements are given an opportunity to ask questions relevant to their marketing objectives. Additional rewards may be issued by the server when correct answers are entered by the prospect or prospects. These rewards can take the form of points (to be accumulated for a future prize claim) or lottery prizes or actual rewards (i.e. free parking time, etc.). None of the advertisement systems used or known to this date include the features of the system claimed in the present application.

### SUMMARY OF THE INVENTION

It is one of the main objects of the present invention to provide a system that effectively engages a prospect and provides accurate information to the advertiser regarding the effectiveness of the advertising activities.

It is another object of this invention to provide a system that engages a prospect through the use of rewards calibrated for the provocation of the prospect's actions.

It is still another object of the present invention to provide a system that measures the effectiveness of the advertising campaign undertaken.

It is yet another object of this invention to provide such a system that is inexpensive to maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 is a flowchart summarizing the different steps initial part of the system.

FIG. 2 represents the steps for the engagement program.

FIG. 3 represents a global compute network 15 connecting prospects and participants through computerized addressable stations 22 to a server 32.

### DETAILED DESCRIPTION OF THE EMBODIMENTS OF THE INVENTION

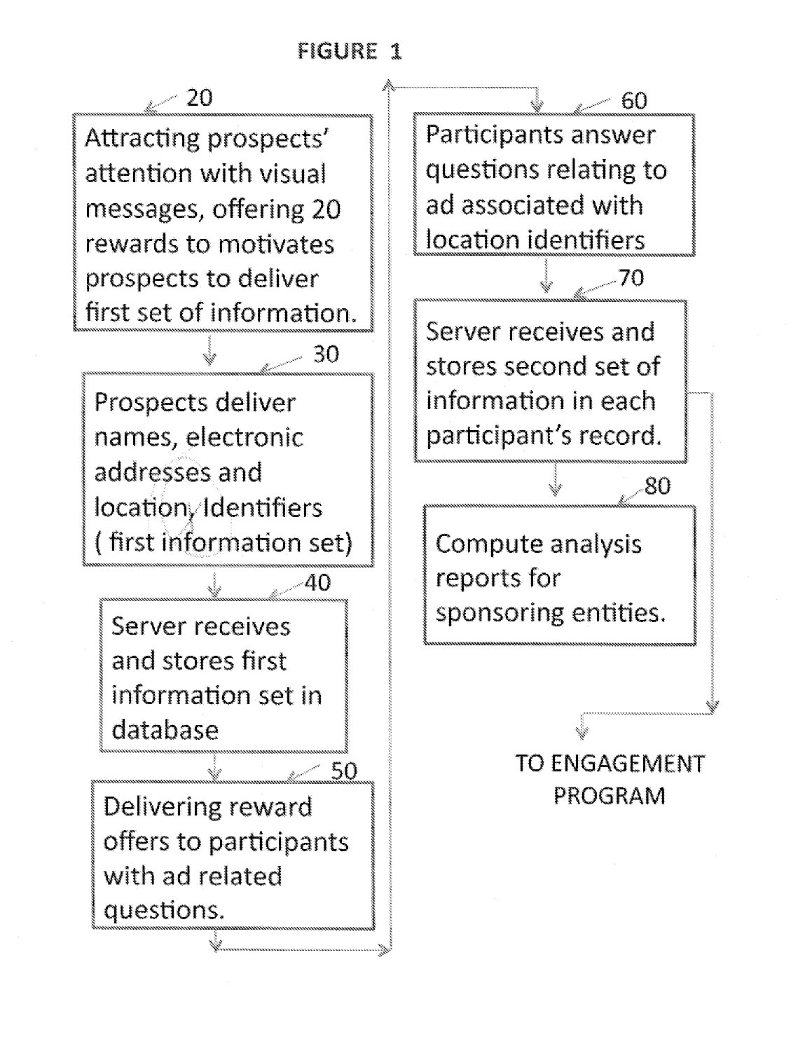

The present invention is generally referred to with numeral 10, it can be observed that it basically includes several steps intended to attract initially the attention of the prospect (with graphic, aural or other means) promising rewards and keeping him/her engaged. This first step is represented in FIG. 1, block 20. During the process valuable information is extracted from the prospect that will be used by sponsoring entities of the system to ascertain patterns useful for their marketing objectives. For the purposes of this application, prospects will be members of the public at large targeted by the sponsoring entities. Sponsoring entities are those seeking the marketing information the system will provide from prospects as potential customers of the sponsors. Once a prospect submits (preferably via electronic means, i.e. Facebook, or similar portals) his/her particulars they are referred to as participants.

A system or method for true one to one advertising, comprises several steps,

A. The first step in practicing the method is typically providing a display that attracts a prospect's attention with a message, such as, a text with or without graphics. It is also possible to attract a prospect's attention with a combination of a text, graphics and sound.

Displaying (graphics, text, etc.) or broadcasting messages (or sounds including music) to prospects is intended to attract their attention based on rewards to be earned if an electronic address (such as electronic mail address, SMS or other electronic means) is provided by a prospect along a predetermined identifier associated with the advertising message. This is requested from the prospect to ascertain the location or source of the advertising message. This first step is identified as block 20 in FIG. 1.

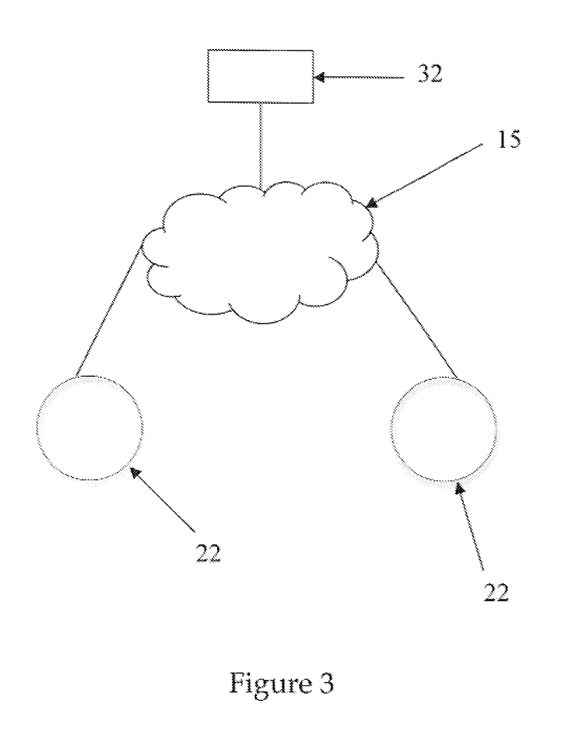

A prospect delivers this information to server 32 using a network 15 connected computerized devices 22 used by the prospects, as seen in FIG. 3. A global computer network 15 is connected to a server having a database assembly and receives the prospect's information. This second step is represented by block 30 in FIG. 1.

The message seen and/or heard by the prospects, in whatever form is implemented, includes an identifier that can be a number, a word or an alphanumeric string. The message will also request the prospect to transmit his/her electronic mail address (email), or other means for contacting the prospect, along with the identifier to a server administrated by the operator of the system. To induce a potential prospect to act (transmit the electronic mail address and the identifier, a reward or incentive is offered). The reward could take any number of forms. The reward could be immediate (i.e. allowing 20 minutes of free parking) or participation in a lottery with attractive prizes, etc. There is complete latitude as to the message contents, graphics, sound and the types of rewards offered. The objective being to cause a potential prospect to provide his/her email (or other means of contacting him electronically) and the unique identifier associated with the location of the display containing the message.

B. The next step includes receiving and storing through server 32 the first set of information sent by the prospect. The first set of information includes the prospect's electronic address and unique identifier for the location or source of the advertising or promotional message. The first set of information is stored with the date and time of receipt of the electronic mail addresses and unique identifier. Optionally, the prospect's name may be delivered also and stored by server 32. This step is represented in block 40.

C. In the next step, reward offers are delivered by server 32 including graphics, text, sounds (i.e. music, messages, trivia questions, etc.) to the now participants (from this point on the prospects are considered participants) depending on pre-programed data and instructions (based on the identifier received from the participant and other information such as the day and time it was received) stored in the server to invite replies from participants in consideration for additional rewards. These reward offers are designed having the interest of the sponsoring entities in mind. For example, a sponsoring entity may be interested in determining how effective a new logo is. Then, one of the questions can be designed having multiple choice answers that include the particular features of the logo. The question may include several answers to determine the recollection of the participant after a predetermined time of having received the first set of information. Depending on the number of correct answers, the sponsoring entity obtains information relating to the penetration of the logo in question. Other marketing information can be obtained from answers received from the participants with different degrees of creativity or interest by the sponsoring entities. This step is represented in block 50. This step requires the use of a server with sufficient hardware and software resources to be connected to a global computer network and being capable of receiving, storing and processing the first amount of information sent the prospect. The first amount of information is stored in a record in a database device of server 32 along with the date and time the first amount of information was received.

D. The reply from a participant as a third set of information is compiled with the participant's already established account in the server's databases. When a second set of information is received by server 32 from participants, it is stored and correlated with pre-programed queries that will permit server 32 to formulate offers for the sale of goods and/or rendering services. As server 32 gains more information from participants the offers become more relevant.

E. The next step involves preparing complete analysis of the data with reports for sponsoring entities including adverting effectiveness information relating to the identifiers being sponsored. This step is identified with numeral 80.

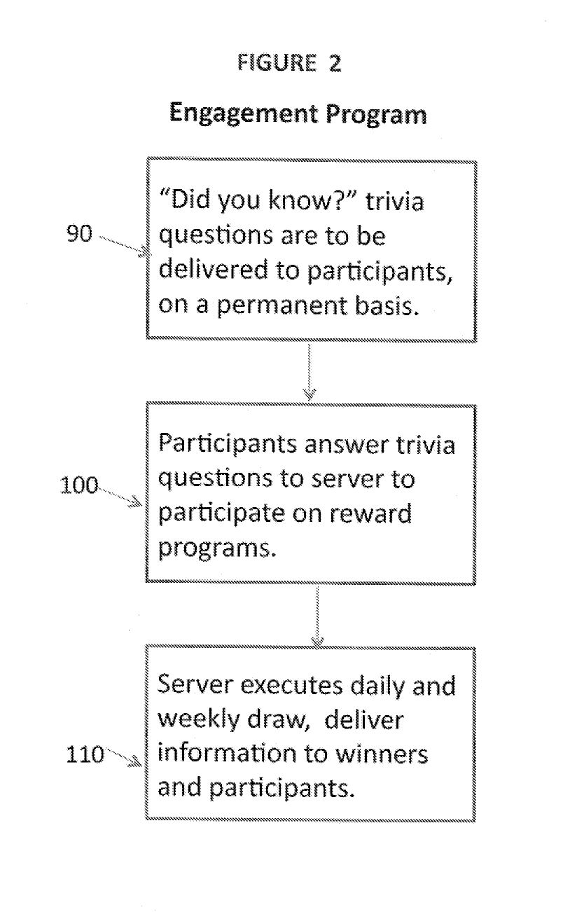

F. From this point on the participants are engaged with the information and rewards sent by server 32. Selectively, additional amounts of information are delivered to the participants depending on pre-programed data and instructions in the server to invite additional replies in consideration for additional rewards. The additional batches of information may include trivia questions, the number of winners of the rewards promised in periodic draws or similar announcements. This step is identified with numeral 90 in FIG. 2.

Participants answer trivia questions or otherwise provide additional information included by additional promised incentives. This step is represented with numeral 100 in FIG. 2. Finally, in step 110 server 32 continues to execute daily and weekly draws, delivering information to participants including the number of winners.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A system for advertising, comprising the steps of:
A) displaying at least one advertising message to attract prospects' attention based on rewards to be earned including an identifier associated with said message, said prospects having access to a computerized station connected to a global computer network;
B) receiving by a server from said prospects through said global computer network a first set of information that includes at least one electronic mail address and at least one identifier and storing as individual records in a computerized database device in said server and storing the date and time of receipt of said first set of information, and said server being connected through a global computer network to said prospects that are converted to participants;
C) transmitting through said network to said prospects a second set of information that includes predetermined incentives awarded to said participants based on a predetermined number of conditions including actions taken or omitted by said participants over a predetermined period of time;
D) receiving and storing said server a third set of information from said participants in said server's database device along with the date and time of receipt; and
E) selectively delivering a fourth set of information to said participants for said messages based on pre-programed data and instructions on said server provided by at least one sponsor to prompt replies from participants in consideration for additional rewards if relevant to said third set of information.

2. The system set forth in claim 1 wherein said at least one sponsor offers goods and/or services and said server further including a database containing records relating to said goods and/or services so that said set of information includes requests for information related to said goods and/or services.

3. Thee system set forth in claim 2, further including the step of:
F) compiling marketing reports from each of said records associated with said identifiers and transmitted to at least one of said sponsors based on said first, second, third and fourth sets of information.
